(19) United States
(12) Patent Application Publication
(10) Pub. No.: US 2023/0166950 A1
(43) Pub. Date: Jun. 1, 2023

(54) HOISTING DEVICE WITH MULTIPLE LINE TYPES ON DRIVESHAFT

(71) Applicant: Hall Labs LLC

(72) Inventors: David R. Hall, Provo, UT (US); Jerome Miles, Spanish Fork, UT (US)

(73) Assignee: Hall Labs LLC, Provo, UT (US)

(21) Appl. No.: 18/060,539

(22) Filed: Nov. 30, 2022

Related U.S. Application Data
(60) Provisional application No. 63/284,390, filed on Nov. 30, 2021.
(60) Provisional application No. 63/373,327, filed on Aug. 23, 2022.
(60) Provisional application No. 63/373,324, filed on Aug. 23, 2022.

(51) Int. Cl. B66D 1/12; B66D 1/38; B66D 1/26

(52) U.S. Cl. CPC B66D 1/12; B66D 1/26; B66D 1/38; B66D 1/50

(57) ABSTRACT

Disclosed is a system for manipulating an object and providing at least one utility winch. The system includes a motor and a driveshaft having an axis and being coupled to the motor. The system includes a first spool on the driveshaft being rotatable with the driveshaft by the motor and a first line for lifting an object, the first line attached to the first spool. The system also includes a second spool on the driveshaft being rotatable with the driveshaft by the motor, and a second line attached to the second spool, the second line configured to deliver at least one utility selected from electric power, data, and fluid.

### CROSS-REFERENCE TO RELATED PATENT APPLICATIONS

This application claims priority to U.S. Provisional Pat. Application No. 63/284,390, entitled “Hoisting Device with Multiple Line Types on Driveshaft,” filed on Nov. 30, 2021. This application also claims priority to U.S. Provisional Pat. Application No. 63/373,327, entitled “Winch with Supporting Tie Rod,” filed on Aug. 23, 2022. This application also claims priority to U.S. Provisional Pat. Application No. 63/373,324, entitled “Raisable Grow System,” filed on Aug. 23, 2022. The entire disclosures of these three prior applications are incorporated herein by reference.

### TECHNICAL FIELD

The present disclosure is directed to the field of lifters, hoists, and winches.

### BACKGROUND

Lifters, hoists and winches are used extensively to lift, lower, or pull loads of various kinds. Such devices typically include a line, such as a cable or chain, wrapped around a spool. To lift, lower, or pull a load, the spool may be manually rotated or driven with a motor, such as an electrical, hydraulic, or pneumatic motor. When rotation is not desired, a braking mechanism may be used to prevent the spool from turning. This may maintain tension in the line, keep a load suspended, or prevent the release or unspooling of the line. To keep the line from bunching on the spool, some hoists or winches may include guides or other mechanisms to evenly wind the line around the spool.

Although a wide variety of lifters, hoists and winches are available, many have shortcomings that prevent or discourage their use in various applications. For example, some hoists or winches are bulky or cumbersome, which may prevent their use in applications where greater compactness is required or desired. Other hoists and winches may be economically infeasible for use in applications such as consumer or residential applications due to their complexity or expense.

Maintaining a flexible line in an orderly way and preventing excessive slack, bunching, and misalignment ensures proper winch operation. Without proper spacing, tension, and alignment the flexible line can become jammed or wear unevenly leading to material degradation or even failure. There is a need in the art for a winch that can maintain a flexible line in an efficient way to ensure a long effective life of the device.

### SUMMARY

Embodiments of the present disclosure are directed to a system for manipulating an object and providing at least one utility winch. The system includes a motor and a driveshaft having an axis and being coupled to the motor wherein the motor rotates the driveshaft around the axis. The system also includes a first spool on the driveshaft being rotatable with the driveshaft by the motor and a first line for lifting an object, the first line attached to the first spool. The system also includes a first line guide configured to translate axially along the first spool to thereby wind the first line in a first helical path on the first spool when the driveshaft is rotated in one direction and to unwind the first line from the first helical path when the driveshaft is rotated in an opposite direction. The system also includes a second spool on the driveshaft being rotatable with the driveshaft by the motor, and a second line attached to the second spool, the second line configured to deliver at least one utility selected from electric power, data, and fluid. The system also includes a second line guide configured to translate axially along the second spool to thereby wind the second line in a second helical path on the second spool when the driveshaft is rotated in one direction and to unwind the second line from the second helical path when the driveshaft is rotated in an opposite direction.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a side view of a multiple spool driveshaft assembly for a winch according to embodiments of the present disclosure.

FIG. 2 is an enlarged view of a spool assembly according to embodiments of the present disclosure.

FIG. 3 is an end view of the driveshaft assembly according to embodiments of the present disclosure.

FIG. 4 is a schematic cross-sectional end view of a driveshaft and spool having a non-circular cross-sectional interface according to embodiments of the present disclosure.

FIG. 5 is a schematic cross-sectional end view of a driveshaft having depressions and spool having matching protrusions according to embodiments of the present disclosure.

FIG. 6 is an illustration of a winch assembly including two multiple spool driveshafts according to embodiments of the present disclosure.

FIG. 7 is an illustration of a multiple spool driveshaft assembly in which two spools are used for lifting lines and the other two spools deliver utilities according to embodiments of the present disclosure.

FIG. 8 illustrates a two-spool, single driveshaft assembly according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “winch” refers to lifting or pulling device consisting of a line winding around a horizontal rotating drum, turned by a crank or by motor or other power source.

As used herein, “winch,” “hoist,” “lift,” “winching device,” “hoisting device,” and “lifting device” are meant to refer to an apparatus that can be actuated to selectively raise and lower an object. These terms are generally interchangeable except for where specifically noted herein.

“Spool” is meant to refer to a generally cylindrical member that rotates to wind a line thereon.

“Line” is meant to refer to a cable, cord, wire, or other suitable interchangeable generally elongated, flexible, member that winds onto the spool.

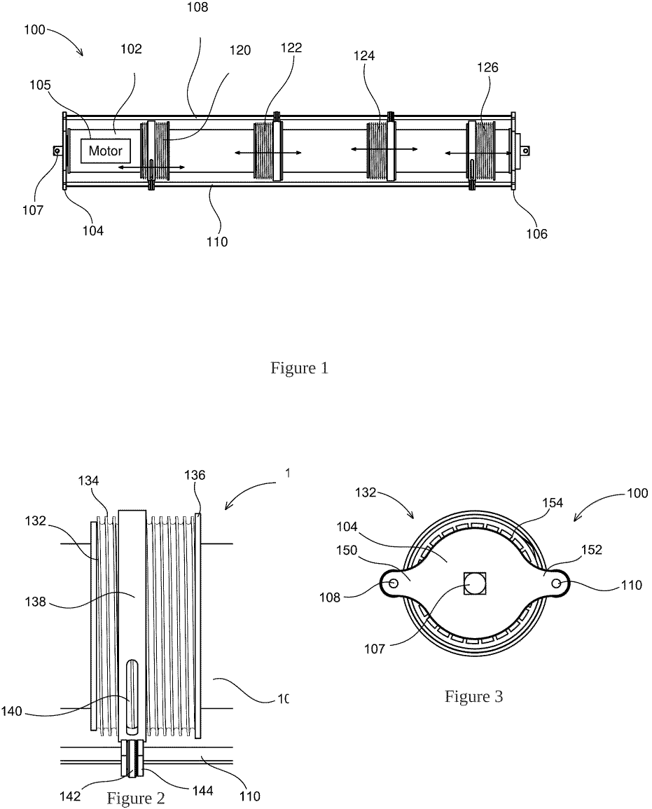

FIG. 1 is a side view of a multiple spool driveshaft assembly 200 for a winch according to embodiments of the present disclosure. The driveshaft assembly 200 can be used in a similar way to other winches that are used in garages or other such places to lift objects up and down as needed. The winches include a flexible line that winds onto and off of a spool to retract and extend the line from the winch. The line can be attached to any object to be lifted.

The driveshaft assembly 200 includes a driveshaft 202 that is an elongated cylindrical member. The length of the driveshaft 202 can vary as needed according to various installations. The assembly also includes a first end plate 204 and a second end plate 206 opposite the first end plate 204. A motor 205 can be located within the driveshaft 202 or can be externally mounted and provides the power to rotate the driveshaft 202. The driveshaft 202 can include a key 207 that can be used to mount the driveshaft 202 to the motor 205 in the case of an external mount. The assembly 200 also includes a first rail 208 and a second rail 210 rotatably connected to the end plates 204, 206, respectively. In some embodiments there may be a single rail.

The driveshaft assembly 200 also includes four spool assemblies: first spool assembly 220, second spool assembly 222, third spool assembly 224, and fourth spool assembly 226. There may be any suitable number of spool assemblies as desired for a given installation. In some embodiments each individual spool assembly is identical; however, in some embodiments each spool assembly can carry a different type of line, such as a load-bearing line, a power/data cable, or even a fluid conduit such as an air tube or a water tube. As used here, the term “fluid” can refer to a vacuum.

The spool assemblies are fitted to the driveshaft 202 and can be selectively moved along the length of the driveshaft 202. In some embodiments the spool assemblies are friction fit onto the spool assemblies such that they are movable by grasping and sliding them along the driveshaft 202 but are otherwise maintain their position. In some embodiments there is a fastener such as a lever or set screw or any other suitable fastener that enables selective placement of the spool assemblies along the driveshaft 202. In some embodiments the driveshaft 202 is smooth, allowing for continuous placement of the spool assemblies at any desired position. In other embodiments the driveshaft 202 can have notches that receive a detent on the interior of the spool assemblies at desired spacings. In still other embodiments the driveshaft 202 may have a hexagonal shape to allow axial sliding of the spools but ensuring that the spools rotate with the driveshaft 202. Other faceted shapes are also possible and is not limited to a hexagonal shape.

In the depicted embodiment, the first spool assembly 220 and fourth spool assembly 226 are attached to the second rail 210, and the second spool assembly 222 and third spool assembly 224 and fourth spool assembly 226 are attached to the first rail 208. It is to be appreciated that this arrangement can vary as desired. There may be one, two, three, or more rails as needed, and any number of the spool assemblies can be attached to any of the rails.

The ability to move the spool assemblies along the driveshaft 202 enables the lines to be positioned at different points along the driveshaft 202 which can then be attached to an object to be lifted. By contrast, using two independent winches requires synchronization between the winches to achieve uniform raising and lowering of two or more lines. The driveshaft assembly 200 eliminates all synchronization issues because a single motor turns the spools at the same rate.

FIG. 2 is an enlarged view of a spool assembly 230 according to embodiments of the present disclosure. The spool assembly 230 includes a spool 232 having a helical groove 234 formed in an external surface of the spool 232. The helical groove 234 carries a line (not shown) wound around the spool 232. The spool 232 includes a flange 236 at one end of the spool 232 to provide an attachment point for the line. The spool assembly 230 also includes a line guide 238 that encircles the spool 232 and allows the line to wind onto the spool. The line guide 238 has a slot 240 through which the line passes.

The spool assembly 230 also includes a tensioning wheel 242 and a wheel support 244 to align the line as it winds onto and off of the spool 232. The wheel support 244 is mounted to the rail 210 with the tensioning wheel 242 being rotated by rotation of the rail 210, while the wheel support 244 allows the rail 210 to rotate within it. In some embodiments the wheel support 244 comprises a one-way bearing that can transfer torque in one direction and allows free movement in the other direction. The rotation of the rail 210 causes the one-way bearing to rotate the tensioning wheel 242 as the spool 232 rotates to pay out the line and to provide a slight tension to the line to ensure the line does not slack as it unwinds. When the spool 232 is rotated to wind the line, the one-way bearing does not transmit torque from the rail and the tensioning wheel 242 therefore does not inhibit the line winding around the spool 232. The rail 210 can rotate at a rate that causes the tensioning wheel 242 to slip slightly as the line is wound to the spool 232. The friction and slipping ensures that the line winds properly. In other words, the wheel speed is slightly faster than the line speed. The line guide 238, wheel support 244, and tensioning wheel 242 all move axially relative to the spool 232 as the spool 232 rotates. In some embodiments the line guide 238 is moved axially by the line, and in other embodiments the line guide 238 is keyed to the spool 232 such that the helical groove 234 causes the axial movement.

The tensioning wheel 242 of the present disclosure contacts an exposed surface of the line as it winds onto the spool 232 and moves at a speed based on the rotational speed of the spool 232. The radius is measured from the center of rotation of the spool 232, to the exposed surface of the line. This speed is referred to herein as the “line speed.” The line speed may also be referred to as the tangential speed. The tensioning wheel 242 has a contact surface that contacts the line. The tensioning wheel 242 rotates at a certain rotational rate which can be manipulated as needed. The speed of the contact surface of the tensioning wheel 242 is referred to herein as the “tensioning wheel speed” or “tangential tensioning wheel speed.”

The gears of the winch and the tensioning wheel itself are constructed such that the tensioning wheel speed is between 1% and 50% faster than the line speed. The dimensions of the spool 232, line, and tensioning wheel 242 may vary. Accordingly, the tensioning wheel 242 frictionally slips along the line slightly to ensure there is tension on the line as it pays out. That is, the wheel drags along the line using the friction between the two to create the tension. If the speeds were identical there would be no frictional slip and the movement would be one-to-one. With a speed differential the wheel “slips” or “drags” along the line, thereby creating the desired tension. As the line is wound onto the spool 232, the one-way bearing allows the tensioning wheel 242 to spin freely, whether or not it contacts the line.

FIG. 3 is an end view of the driveshaft assembly 200 according to embodiments of the present disclosure. The key 207 for mating to an externally mounted motor is visible having a squared profile. A hexagonal or other torque-transmitting profile can also be found in some embodiments. The end plate 204 is shown and includes a first tab 250 for accommodating the first rail 208, and a second tab 252 for accommodating the second rail 210. The rails can rotate with respect to the tabs. In other embodiments there may be a single rail and accordingly the end plate 204 will have a single tab 250. In still other embodiments there may be three or more tabs accommodating three or more rails. The spool 232 is visible and includes spokes 254 that support the spool 232 and may provide sufficient flexibility to the spool 232 to allow selective movement along the driveshaft while grasping the driveshaft sufficiently firmly that rotation of the motor rotates the spool 232.

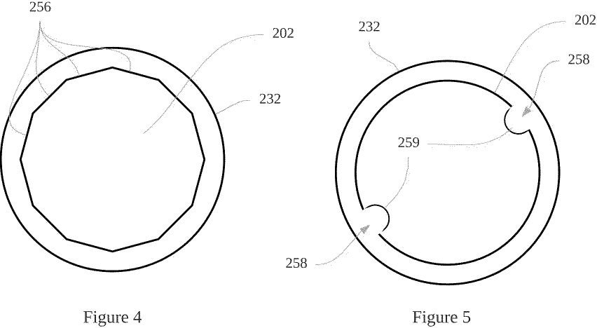

FIG. 4 is a schematic cross-sectional end view of a driveshaft 202 and spool 232 having a non-circular cross-sectional interface according to embodiments of the present disclosure. The driveshaft 202 has 12 flat sides 256 in the shown embodiment; however, any number of sides is possible within the scope of the present disclosure. The non-circular nature of the driveshaft 202 prevents the spool (not pictured) to slide along the driveshaft but prevents rotation of the spool 232 around the driveshaft 202 thus allowing the driveshaft to drive the spool 232 without slipping.

FIG. 5 is a schematic cross-sectional end view of a driveshaft 202 having depressions 258 and spool 232 having matching protrusions 259 according to embodiments of the present disclosure. The depressions 258 can be rounded, squared, or any other suitable shape that will constrain the protrusions 259 in the spool 232 to match the depressions 258 such that the spool 232 and driveshaft 202 do not rotate relative to one another. The depressions 258 and protrusions 259 may be located at a specific axial position on the driveshaft 202 in which case the spool 232 has specific axial positions in which to operate. In other embodiments the depressions 258 extend axially along at least part of the length of the driveshaft 202 such that there may be more than one axial position for the spool 232 to engage. In some embodiments the depressions 258 extend the entire length of the driveshaft 202. The relative size of the depressions 258 and protrusions 259 may be larger or smaller than what is shown. The protrusions 259 may be spring-loaded such that the spool 232 can slide along the driveshaft 202 with the protrusions 259 recessed into the spool 232, and when the protrusions 259 reach a depression 258 the protrusion 259 extends into the depression 258. The depressions 258 may be rounded such that the depression/protrusion interface prevents relative rotation, but if sufficient torque is applied the protrusion 259 will recess and allow the spool 232 to rotate. In some embodiments the depressions 258 are rounded in the axial direction to permit the protrusions 259 to leave a depression 258 if moved axially relative to the driveshaft 202 but preventing relative rotation between the spool 232 and driveshaft 202. In some embodiments the protrusions 259 can be accessed from the outer surface of the spool 232 such that without a line wound the protrusions 259 can be actuated manually to release the spool 232 from the driveshaft 202.

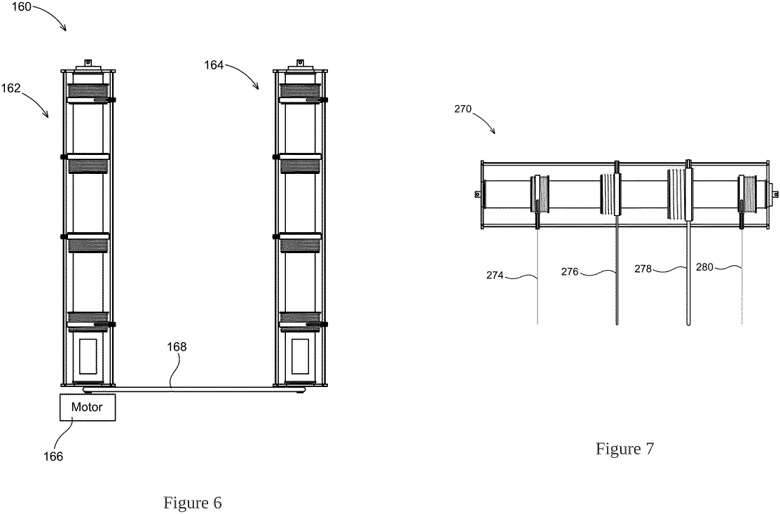

FIG. 6 is an illustration of a winch assembly 260 including two multiple spool driveshafts according to embodiments of the present disclosure. The winch assembly 260 includes a first multiple spool driveshaft assembly 262 and a second multiple spool driveshaft assembly 264. A motor 266 is coupled to the first multiple spool driveshaft assembly 262 directly and a coupler 268 connects the motor 266 to the second multiple spool driveshaft assembly 264. Accordingly, the motor 266 can operate both multiple spool driveshaft assemblies in unison. The coupler 268 can be a belt or a chain or any other suitable mechanical equivalent.

In other embodiments each multiple spool driveshaft assembly has its own motor, and the motors are synchronized together by a wireless connection, for example as taught in U.S. Pat. No. 9,624,076, entitled Synchronized Motorized Lifting Devices for Lifting Shared Loads. In still other embodiments three or more multiple spool driveshaft assemblies can be used.

The winch assembly 260 enables a plurality of lifting points, each from a separate spool. The spools can be placed in any available position resulting in many positioning possibilities. Using two or more multiple spool driveshafts allows for three points of contact which can provide more stability and a more secure vertical path for the object to be lifted. One such application of this winch assembly 260 is for an appliance such as a washing machine in a modular dwelling. Washing machines are relatively heavy and may be desired to remain in a precise vertical path. The winch assembly 260 can have one spool for each corner of the washing machine to ensure that it can be raised and lowered precisely without fear of jamming or wobble.

FIG. 7 is an illustration of a multiple spool driveshaft assembly 270 in which each spool carries a line of a different variety according to embodiments of the present disclosure. In this embodiment, at least one line is configured to lift and lower an object and least one other line is configured to deliver at least one utility selected from electric power, data, and fluid. In the depicted embodiment, the device has two load-bearing lines and two utility delivering lines. For example, the multiple spool driveshaft assembly 270 can carry an electrical line capable of transmitting electrical power and/or signals. Another possibility is a fluid line capable of conveying a fluid such as water, air, fuel, or any other fluid substance. In a deployment such as the washing machine for a modular dwelling discussed above for example, the washing machine may need to be physically raised and lowered, and provided with electricity for information and power, and the water supplied to the washing machine can also be provided via a line provided by one of the spool assemblies.

In the depicted embodiment a first line 274 and fourth line 280 may be load-bearing physical winch lines. The second line 276 may deliver electric power and the third line 278 may be deliver fluid such as water. The lines may one or more of several possible line types. The line types include: fiber optic, electrical power, electrical data, USB, Ethernet, audio, HDMI, display port, PS/2, SATA, LlGHTNING™, or Firewire™. Fiber optic lines are categorized herein as electrical lines inasmuch as fiber optics are used inter alia to transmit data. The line types may also be for fluids, such as a gas or a liquid. The gas may be air, oxygen, hydrogen, nitrogen, helium, or any other conceivable gas. The liquid may be water, gasoline, hand sanitizer, or any other conceivable liquid material.

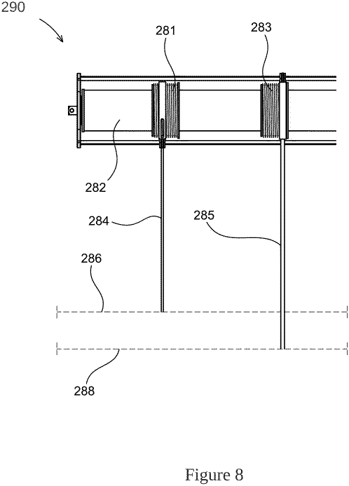

The non-load bearing lines, i.e. the lines delivering a utility, may be connected with a small amount of slack to be sure there is no unwanted tension on a line that is not designed to hold the weight. In some embodiments the various lines have different diameters, and the corresponding spools can accommodate the different diameters. The spools can have different helical groove sizes and pitches. The spool assemblies also have line guides such as that shown and described in detail with respect to FIGS. 7 and 8 that provide tension on the lines using tensioning wheels and wheel supports. To accommodate lines of different sizes, the rails and tensioning wheels can be configured to frictionally slip along the lines so there is tension as the lines are paid out from the spools. The wheel supports for the spool assemblies can feature one-way bearings that tension the line when the line is paying out and allows the lines to pay out freely in the other direction.

To facilitate a line carrying a fluid, it is preferred to use a rotary union, i.e. a coupling of the line with a source of the fluid through means of a union that allows for rotation of the drive shaft and spool. Such a union provides a seal between the stationary supply, such as pipe or tubing and the rotating spool to enable the flow of a fluid into and/or out of the line.

To facilitate a line carrying electricity, either to power a device or to transmit analog or digital electric signals, it is preferred to equip the device with at least one slip ring, namely a coupling that provides a sliding electrical contact so that the stationary line can be in electrical communication with the rotating spool and thus the line carrying electricity. An induction coupling could also be used in certain embodiments.

FIG. 8 illustrates a two-spool, single driveshaft assembly 280 according to embodiments of the present disclosure. A first spool 281 is at a first position on the driveshaft 282. A second spool 283 is at a second position on the driveshaft 282. The first spool 281 carries a first line 284 and the second spool 283 carries a second line 285. The lines may be the same line type or a different line type. The lines may have the same diameter, or the diameters may be different. The spools may have the same dimensions in terms of circumference and pitch of the helical groove, or they may be different.

The first line 284 has a first deployment distance 286 and the second line 285 has a second deployment distance 288. An example of a desired deployment distance may be a tool on a workbench. The first line 284 may carry an electrical power line that connects to the tool on the workbench. The second line 285 may carry an electrical power line for a different tool that sits on the ground next to the workbench. The driveshaft assembly 280, including spools 281, 283 and the various dimensions of the spools including diameter, helical groove shape, etc. is constructed such that both the first line 284 and the second line 285 reach their respective deployment distances once the driveshaft 282 has rotated a predetermined distance. The spools 281, 283 will complete the same number of revolutions, but the sizes of the spool and the pitch of the helical groove and the effective diameter of each respective line on the spool varies to achieve the same deployment distance. In some embodiments the deployment distance includes a certain amount of slack in the line once the line reaches the deployment distance. In some embodiments the deployment distance is the same, but the diameter of the lines is different, and the spool and helical groove dimensions are adjusted accordingly.

It is noted that, although much of the discussion above has involved lifting objects with the winches described, the disclosed winches can also be used for pulling objects. The tensioning wheel, that assures that the line is pulled off the spool as it is being unwound, is particularly advantageous to these pulling embodiments, that do not have gravity to assist pulling the line off the spool.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for manipulating an object and providing at least one utility, comprising:
a motor;
a driveshaft having an axis and being coupled to the motor wherein the motor rotates the driveshaft around the axis,
a first spool on the driveshaft being rotatable with the driveshaft by the motor;
a first line for lifting an object, the first line attached to the first spool;
a first line guide configured to translate axially along the first spool to thereby wind the first line in a first helical path on the first spool when the driveshaft is rotated in one direction and to unwind the first line from the first helical path when the driveshaft is rotated in an opposite direction;
a second spool on the driveshaft being rotatable with the driveshaft by the motor;
a second line attached to the second spool, the second line configured to deliver at least one utility selected from electric power, data, and fluid;
a second line guide configured to translate axially along the second spool to thereby wind the second line in a second helical path on the second spool when the driveshaft is rotated in one direction and to unwind the second line from the second helical path when the driveshaft is rotated in an opposite direction.

2. The system of claim 1, wherein the utility is data, and wherein the second line is configured to deliver data by either digital, analog, or optical signals.

3. The system of claim 1, wherein the utility is electric power, and wherein the second line is in electrical communication with a power source by at least one slip ring connection.

4. The system of claim 1, wherein the utility is fluid and wherein the fluid is selected from water, fuel, lubricant, liquid fertilizer, air, and vacuum.

5. The system of claim 3, further comprising a rotary union between the second spool and a source of the fluid.

6. The system of claim 1 wherein the first line has a first diameter, and the second line has a second diameter different than the first diameter, and wherein the first line has a first deployment distance and the second line has a second deployment distance.

7. The system of claim 6 wherein the first deployment distance and second deployment distance are equal.

8. The system of claim 1, further comprising a tensioning wheel configured to tension the first line as the first line is unwound from the first spool by rotation of the first spool.

9. The system of claim 1 wherein the line guide is spaced apart from the driveshaft.

10. The system of claim 1 wherein the driveshaft and one or more of the spools have a depression/protrusion interface wherein the driveshaft has a depression or a protrusion, and the spool has a protrusion or a depression, wherein the depressions and protrusions match and are configured to fix the spool relative to the driveshaft.

11. The system of claim 10 wherein the protrusion is spring-actuated and biased toward extending into the depression.

12. The system of claim 1 wherein the first line guide comprises a driven wheel that is rotated by the motor, wherein the driven wheel contacts the first line as the first line is unwound from the first spool.

13. The system of claim 12 wherein the driven wheel moves at a wheel speed and the line unwinds from the spool at a line speed, and wherein the wheel speed is at least 5% faster than the line speed such that the wheel drags along the first line and thereby creates tension in the first line.

14. The system of claim 1 wherein the second line guide comprises a driven wheel that is rotated by the motor, wherein the driven wheel contacts the second line as the second line is unwound from the first spool.

15. The system of claim 12 wherein the driven wheel moves at a wheel speed and the line unwinds from the spool at a line speed, and wherein the wheel speed is at least 5% faster than the line speed such that the wheel drags along the second line and thereby creates tension in the second line.

16. A system for raising and lowering an object and providing power to the object, comprising:
a motor;
a driveshaft having an axis and being coupled to the motor wherein the motor rotates the driveshaft around the axis,
a first spool on the driveshaft being rotatable with the driveshaft by the motor;
a first line for raising and lowering an object, the first line attached to the first spool;
a first line guide configured to translate axially along the first spool to thereby wind the first line in a first helical path on the first spool when the driveshaft is rotated in one direction and to unwind the first line from the first helical path when the driveshaft is rotated in an opposite direction;
a second spool on the driveshaft being rotatable with the driveshaft by the motor;
a power line attached to the second spool, the power line configured to deliver at power to the object;
a power line guide configured to translate axially along the second spool to thereby wind the power line in a second helical path on the second spool when the driveshaft is rotated in one direction and to unwind the second line from the second helical path when the driveshaft is rotated in an opposite direction.

17. The system of claim 16, further comprising:
a third spool on the driveshaft being rotatable with the driveshaft by the motor;
a fluid line attached to the third spool, the fluid line configured to deliver a fluid to the object;
a fluid line guide configured to translate axially along the third spool to thereby wind the fluid line in a third helical path on the third spool when the driveshaft is rotated in one direction and to unwind the fluid line from the third helical path when the driveshaft is rotated in an opposite direction.

18. The system of claim 17, wherein the fluid is water.

19. The system of claim 17, wherein the fluid is air.

20. The system of claim 17, further comprising:
a fourth spool on the driveshaft being rotatable with the driveshaft by the motor;
a data line attached to the third spool, the fluid line configured to transmit data to and from the object;
a data line guide configured to translate axially along the fourth spool to thereby wind the data line in a fourth helical path on the fourth spool when the driveshaft is rotated in one direction and to unwind the data line from the fourth helical path when the driveshaft is rotated in an opposite direction.
